(19) United States
(12) Patent Application Publication
(10) Pub. No.: US 2024/0396073 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/442,436

(22) Filed: Feb. 15, 2024

(30) Foreign Application Priority Data
May 26, 2023 (JP) 2023-087157

(51) Int. Cl. H01M 10/04; H01M 50/107; H01M 50/533

(52) U.S. Cl. CPC H01M 10/0431; H01M 50/107; H01M 50/533

(57) ABSTRACT

The power storage cell includes a wound electrode body and a case that houses the wound electrode body. The wound electrode body includes an outer peripheral surface on which a bulging portion is formed. The case includes an inner peripheral surface facing the outer peripheral surface. On the inner peripheral surface, a groove portion (recessed portion) is provided at a position facing the bulging portion.

### CROSS-REFERENCE TO RELATED APPLICATION

This application claims priority to Japanese Patent Application No. 2023-087157 filed on May 26, 2023, incorporated herein by reference in its entirety.

### BACKGROUND

### 1. Technical Field

The present disclosure relates to a power storage cell.

### 2. Description of Related Art

WO 2020/137547 discloses a power storage device including a wound electrode body provided with a tab lead.

### SUMMARY

The wound electrode body of WO 2020/137547 is provided with a tab lead. When the tab lead is provided, a bulging portion may be formed on the outer peripheral surface of the wound electrode body due to the thickness of the tab lead. In this case, when the wound electrode body is restrained by a case or the like, a local load is applied to the wound electrode body (bulging portion).

The present disclosure has been made in order to address the above issue, and an object thereof is to provide a power storage cell capable of suppressing a local load being applied to a wound electrode body.

An aspect of the present disclosure provides a power storage cell including: a wound electrode body that includes an electrode sheet and a separator; and a case that accommodates the wound electrode body. The wound electrode body is wound such that the electrode sheet and the separator surround a winding axis. The wound electrode body includes an outer peripheral surface on which a bulging portion is formed. The case includes an inner peripheral surface that faces the outer peripheral surface. A recessed portion is provided on the inner peripheral surface at a position facing the bulging portion.

In the power storage cell according to the aspect of the present disclosure, as described above, a recessed portion is provided on the inner peripheral surface of the case at a position facing the bulging portion. This makes it possible to increase the distance between the inner peripheral surface of the case and the bulging portion as compared with the case where the recessed portion is not formed. As a result, the pressure received by the wound electrode body from the inner peripheral surface of the case at the position where the bulging portion is provided can be reduced as compared with the case where the recessed portion is not formed. This makes it possible to suppress a local pressure being applied to the wound electrode body.

In the power storage cell according to the above aspect, preferably, the bulging portion may be formed so as to extend in an axial direction of the wound electrode body. The recessed portion may include a groove portion provided so as to extend along the bulging portion. With such a configuration, the pressure received by the bulging portion extending in the axial direction from the inner peripheral surface of the case can be easily reduced as compared with the case where the groove portion is not formed.

In the power storage cell according to the above aspect, preferably, the outer peripheral surface may include a terminal portion of winding of the wound electrode body. The wound electrode body may include a tape attached to the terminal portion so as to maintain the wound electrode body in a wound state. The bulging portion may be formed by the tape. The recessed portion may be provided at a position facing the tape. With such a configuration, the pressure received by the tape attached to the terminal portion from the inner peripheral surface of the case can be reduced as compared with the case where the recessed portion is not formed. As a result, it is possible to suppress a local pressure being applied to the wound electrode body while maintaining the wound electrode body in a wound state using the tape.

In the power storage cell according to the above aspect, preferably, the bulging portion may be formed by an adhesive material applied between the outer peripheral surface and the recessed portion. With such a configuration, the pressure from the inner peripheral surface of the case can be reduced by the adhesive material as compared with the case where the recessed portion is not formed. As a result, it is possible to improve the vibration resistance of the wound electrode body by fixing the case and the wound electrode body using the adhesive material while suppressing a local pressure being applied to the wound electrode body.

In this case, preferably, the outer peripheral surface may include a terminal portion of winding of the wound electrode body, and the adhesive material may be applied between the recessed portion provided at a position facing the terminal portion and the outer peripheral surface. With such a configuration, it is possible to maintain the wound electrode body in the wound state by bonding the terminal portion using the adhesive material while improving the vibration resistance or the like of the wound electrode body. In addition, since the wound electrode body can be maintained in the wound state using the adhesive material, a tape or the like for maintaining the wound electrode body in the wound state can be omitted.

In the power storage cell according to the above aspect, preferably, the electrode sheet may include a sheet-like current collector, and a tab lead that projects in an axial direction from the current collector. The bulging portion may be formed by the tab lead. The recessed portion may be positioned radially outward of the wound electrode body with respect to the tab lead. With such a configuration, the pressure received by the bulging portion formed by the thickness of the tab lead from the inner peripheral surface of the case can be reduced as compared with the case where the recessed portion is not formed.

According to the present disclosure, it is possible to suppress a local load being applied to the wound electrode body in which the bulging portion is formed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a configuration of a power storage cell according to a first embodiment;

FIG. 2 is a schematic perspective view showing a configuration of a wound electrode body according to the first embodiment;

FIG. 3 is a partially enlarged view of the positive electrode side of FIG. 1;

FIG. 4 is a partially enlarged view of the negative electrode side of FIG. 1;

FIG. 5 is a view illustrating a state in which the wound electrode body and the case according to the first embodiment are separated from each other;

FIG. 6 is a partially enlarged plan view of the vicinity of the groove portion as viewed from Z1 side according to the first embodiment;

FIG. 7 is a partially enlarged plan view of the vicinity of the groove portion as viewed from Z1 side according to the second embodiment;

FIG. 8 is a perspective view illustrating a configuration of a wound electrode body according to a second embodiment;

FIG. 9 is a cross-sectional view illustrating a configuration of a power storage cell according to a third embodiment;

FIG. 10 is a schematic perspective view showing a configuration of a wound electrode body according to a third embodiment;

FIG. 11 is a plan view showing a configuration of a positive electrode plate according to a third embodiment;

FIG. 12 is a plan view illustrating a configuration of a negative electrode plate according to a third embodiment;

FIG. 13 is a cross-sectional view taken along XIII-XIII line of FIG. 11;

FIG. 14 is a cross-sectional view taken along XIV-XIV line of FIG. 12;

FIG. 15 is a partially enlarged plan view of the vicinity of the groove portion as viewed from Z1 side according to the third embodiment;

FIG. 16 is a partially enlarged plan view of the vicinity of the groove portion as viewed from Z2 side according to the third embodiment; and

FIG. 17 is a diagram illustrating a state in which a wound electrode body and a case according to a modification of the first embodiment are separated from each other.

### DETAILED DESCRIPTION OF EMBODIMENTS

Hereinafter, embodiments of the present disclosure will be described in detail with reference to the drawings. In the drawings, the same or corresponding parts are denoted by the same reference numerals, and the description thereof will not be repeated.

### First Embodiment

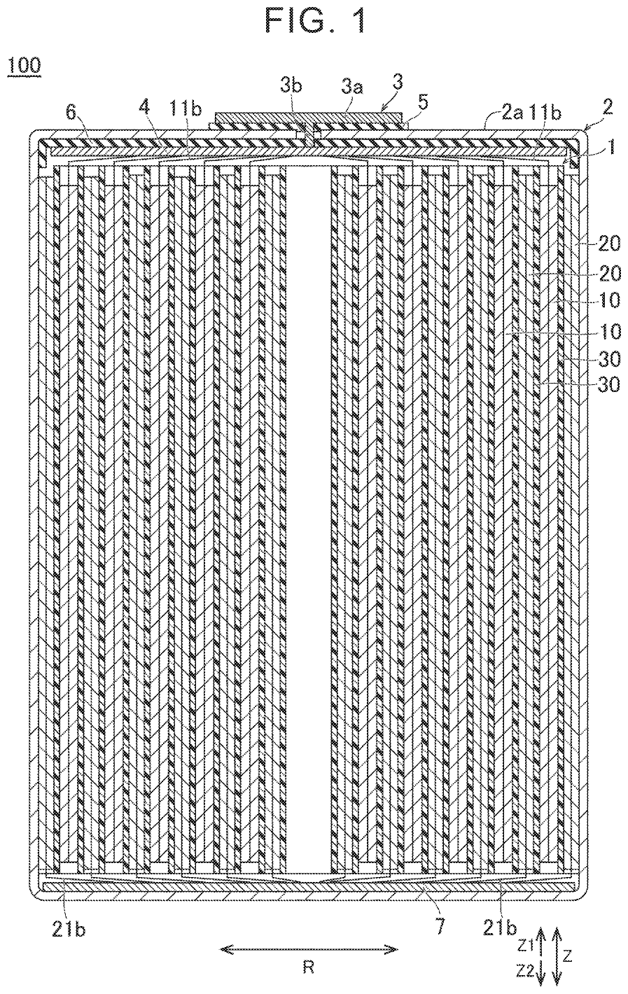

FIG. 1 is a cross-sectional view illustrating an overall configuration of a power storage cell 100 according to an embodiment of the present disclosure. The power storage cell 100 is, for example, a lithium-ion battery mounted on a vehicle. Note that the use and type of the power storage cell 100 are not limited to the above example.

The power storage cell 100 includes a wound electrode body 1, a case 2, a positive electrode terminal 3, a positive electrode current collector plate 4, an external gasket 5, an inner gasket 6, and a negative electrode current collector plate 7.

The wound electrode body 1 is accommodated in the case 2. The case 2 has a cylindrical shape. That is, the power storage cell 100 is a cylindrical battery. The case 2 is made of copper, aluminum, or the like.

The wound electrode body 1 includes a positive electrode plate 10, a negative electrode plate 20, and a separator 30. The separator 30 is provided between the positive electrode plate 10 and the negative electrode plate 20. The separator 30 separates the positive electrode plate 10 from the negative electrode plate 20 while allowing ions (for example, lithium ions) to move back and forth between the positive electrode plate 10 (positive electrode active material) and the negative electrode plate 20 (negative electrode active material). The wound electrode body 1 is constituted by an electrode plate group in which a positive electrode plate 10 and a negative electrode plate 20 are wound with a separator 30 interposed therebetween. Note that each of the positive electrode plate 10 and the negative electrode plate 20 is an example of an “electrode sheet” of the present disclosure.

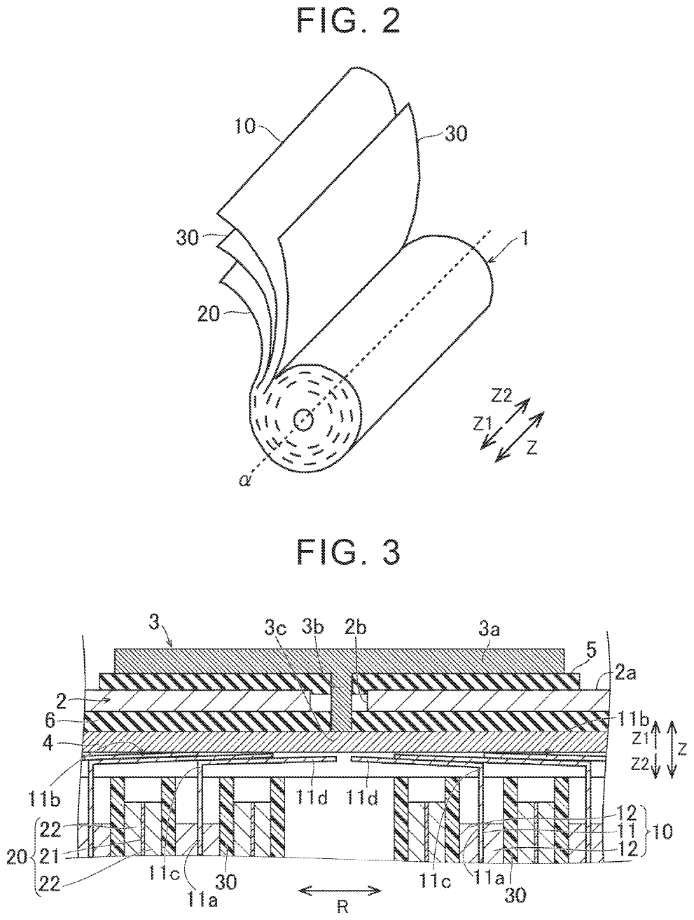

As shown in FIG. 2, the wound electrode body 1 is wound such that the positive electrode plate 10, the negative electrode plate 20, and the separator 30 surround the winding axis α. In FIG. 2, a state in which the winding of the wound electrode body 1 is slightly unwound is illustrated so that the winding state of the wound electrode body 1 can be easily understood.

Referring back to FIG. 1, the positive electrode terminal 3 includes a disc portion 3a and a rivet portion 3b. The rivet portion 3b is connected to the disc portion 3a. The rivet portion 3b is provided so as to extend Z2 from the center of the disc portion 3a. The positive electrode terminal 3 is made of aluminum.

As shown in FIG. 3, the disc portion 3a is disposed on the upper surface 2a (Z1 of the case 2). A through-hole 2b is provided on the upper surface 2a of the case 2. The rivet portion 3b extends from the disc portion 3a disposed outside the case 2 to the inside of the case 2 through the through-hole 2b.

The positive electrode current collector plate 4 is accommodated in the case 2. The positive electrode current collector plate 4 is welded to a later-described positive electrode uncoated portion 11b of the positive electrode plate 10 on Z1 of the wound electrode body 1. As a result, the positive electrode current collector plate 4 is positively charged. The positive electrode current collector plate 4 is welded to Z2 end portion 3c of the rivet portion 3b. Thus, the positive electrode terminal 3 is positively charged.

The external gasket 5 is disposed between the disc portion 3a of the positive electrode terminal 3 and the upper surface 2a of the case 2. Thus, the positive electrode terminal 3 and the case 2 are insulated from each other.

The inner gasket 6 is disposed between the case 2 and the positive electrode current collector plate 4 inside the case 2. Thus, the case 2 and the positive electrode current collector plate 4 are insulated from each other. The rivet portion 3b contacts the positive electrode current collector plate 4 by passing through the inner gasket 6.

The positive electrode plate 10 includes a positive electrode current collector 11 and a positive electrode mixture layer 12. The positive electrode mixture layers 12 are coated on both surfaces in the radial direction (R direction) of the positive electrode current collector 11 (a positive electrode coated portion 11a described later). The positive electrode mixture layer 12 faces the separator 30 in the R direction.

For example, aluminum or the like is used for the positive electrode current collector 11. The positive electrode mixture layer 12 is formed by coating a positive electrode slurry on the surface of the positive electrode current collector 11 and drying the slurry. The positive electrode slurry is a slurry prepared by kneading a material (a positive electrode active material, a binder, or the like) of the positive electrode mixture layer 12 and a solvent. The positive electrode mixture layer 12 is in close contact with the separator 30. The thickness of the positive electrode mixture layer 12 is, for example, 0.1 μm or more and 1000 μm or less.

The positive electrode current collector 11 includes a positive electrode coated portion 11a and a positive electrode uncoated portion 11b. The positive electrode coated portion 11a is a portion of the positive electrode current collector 11 on which the positive electrode mixture layers 12 are coated. The positive electrode coated portion 11a is sandwiched between the separators 30.

The positive electrode uncoated portion 11b is a portion of the positive electrode current collector 11 on which the positive electrode mixture layers 12 are not coated. The positive electrode uncoated portion 11b is located Z1 the positive electrode coated portion 11a. Specifically, the positive electrode uncoated portion 11b protrudes Z1 from the positive electrode coated portion 11a.

The positive electrode uncoated portion 11b includes a portion 11c extending along the Z direction and a portion 11d extending along the R direction. The positive electrode uncoated portion 11b is bent radially inward. The positive electrode uncoated portion 11b is bent in an L-shape. The portion 11d of the positive electrode uncoated portion 11b contacts the positive electrode current collector plate 4. As a result, the positive electrode current collector plate 4 is positively charged. The positive electrode uncoated portion 11b (portion 11d) is welded to the positive electrode current collector plate 4.

A plurality of the positive electrode uncoated portions 11b is arranged side by side along the winding direction. A slit (not shown) is provided between the positive electrode uncoated portions 11b adjacent to each other in the winding direction. Among the plurality of positive electrode uncoated portions 11b, the positive electrode uncoated portions 11b adjacent to each other in the R-direction are provided so as to partially overlap each other.

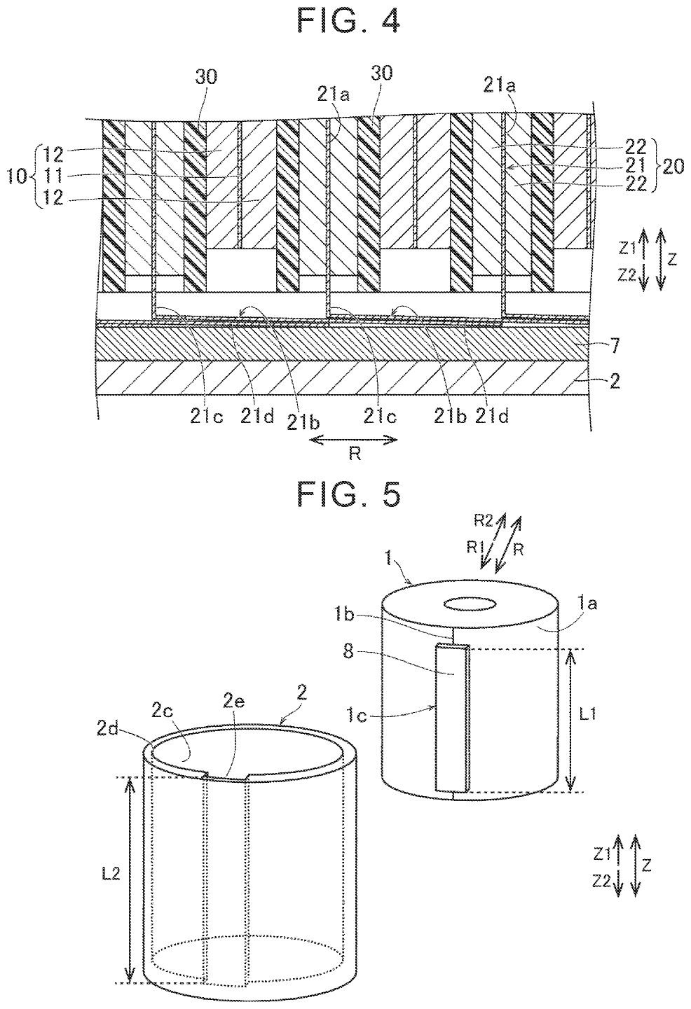

As shown in FIG. 4, the negative electrode current collector plate 7 is accommodated in the case 2. The negative electrode current collector plate 7 is welded to a negative electrode uncoated portion 21b, which will be described later, of the negative electrode plate 20 on Z2 of the wound electrode body 1. As a result, the negative electrode current collector plate 7 is negatively charged. The negative electrode current collector plate 7 is in contact with the case 2. Thus, the case 2 is negatively charged.

The negative electrode plate 20 includes a negative electrode current collector 21 and a negative electrode mixture layer 22. The negative electrode mixture layers 22 are coated on both surfaces in the radial direction (R direction) of the negative electrode current collector 21 (a negative electrode coated portion 21a described later). The negative electrode mixture layer 22 faces the separator 30 in the R direction.

For example, copper or the like is used for the negative electrode current collector 21. The negative electrode mixture layer 22 is formed by coating a negative electrode slurry on the surface of the negative electrode current collector 21 and drying the negative electrode slurry. The negative electrode slurry is a slurry prepared by kneading a material (a negative electrode active material, a binder, or the like) of the negative electrode mixture layer 22 and a solvent. The negative electrode mixture layer 22 is in close contact with the separator 30. The thickness of the negative electrode mixture layer 22 is, for example, 0.1 μm or more and 1000 μm or less.

The negative electrode current collector 21 includes a negative electrode coated portion 21a and a negative electrode uncoated portion 21b. The negative electrode coated portion 21a is a portion of the negative electrode current collector 21 on which the negative electrode mixture layers 22 are coated. The negative electrode coated portion 21a is sandwiched between the separators 30.

The negative electrode uncoated portion 21b is a portion of the negative electrode current collector 21 on which the negative electrode mixture layers 22 are not coated. The negative electrode uncoated portion 21b is located Z2 the negative electrode coated portion 21a. Specifically, the negative electrode uncoated portion 21b protrudes Z2 from the negative electrode coated portion 21a.

The negative electrode uncoated portion 21b includes a partial 21c extending along the Z direction and a partial 21d extending along the R direction. The negative electrode uncoated portion 21b is bent radially inward. The negative electrode uncoated portion 21b is bent in an L-shape. The partial 21d of the negative electrode uncoated portion 21b contacts the negative electrode current collector plate 7. As a result, the negative electrode current collector plate 7 is negatively charged. The negative electrode uncoated portion 21b (partial 21d) is welded to the negative electrode current collector plate 7.

The negative electrode uncoated portions 21b are arranged side by side along the winding direction. A slit (not shown) is provided between the negative electrode uncoated portions 21b adjacent to each other in the winding direction. Further, among the plurality of negative electrode uncoated portions 21b, the negative electrode uncoated portions 21b adjacent to each other in the R-direction are provided so as to partially overlap each other.

FIG. 5 is a schematic perspective view showing a state in which the wound electrode body 1 and the case 2 are separated from each other. As illustrated in FIG. 5, the wound electrode body 1 includes an outer peripheral surface 1a and a terminal portion 1b. The terminal portion 1b is a terminal portion of the winding of the wound electrode body 1. The terminal portion 1b is provided so as to extend along the axial direction (Z direction).

In addition, the wound electrode body 1 includes a tape 8 attached to the outer peripheral surface 1a. The tape 8 is provided on the terminal portion 1b in order to maintain the wound state of the wound electrode body 1. The tape 8 is provided so as to extend in the axial direction (Z direction). That is, the tape 8 is provided along the terminal portion 1b extending along the Z-direction. The tape 8 is provided so as to cover the terminal portion 1b from the radially outer side (R2 side).

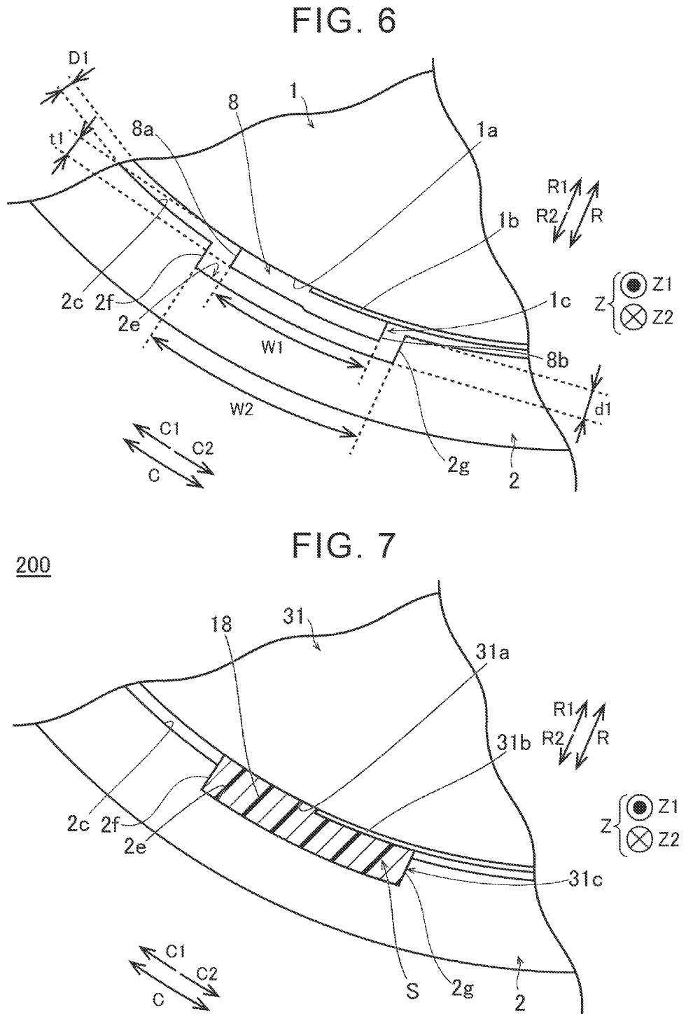

The tape 8 has a thickness t1 (see FIG. 6) in the radial direction (R direction). As a result, in the wound electrode body 1, the bulging portion 1c is formed on the outer peripheral surface 1a due to the tape 8 being attached to the outer peripheral surface 1a. That is, the bulging portion 1c is formed by the tape 8.

The case 2 includes an inner peripheral surface 2c. The inner peripheral surface 2c is provided so as to face the outer peripheral surface 1a of the wound electrode body 1 in the R direction (the radial direction of the wound electrode body 1). The wound electrode body 1 is inserted into the case 2 from the opening 2d on Z1 side of the case 2. Further, the opening 1d is closed by a cover (not shown) after the wound electrode body 1 is disposed. As a result, an upper surface 2a (see FIG. 1) is formed.

Here, in the conventional power storage cell, since the tab lead is provided, a bulging portion may be formed on the outer peripheral surface of the wound electrode body due to the thickness of the tab lead. In this case, when the wound electrode body is restrained by a case or the like, a local weight is applied to the wound electrode body (bulging portion).

Therefore, in the first embodiment, the groove portion 2e is provided on the inner peripheral surface 2c of the case 2 at a position facing the bulging portion 1c (tape 8). The groove portion 2e is provided so as to extend along the bulging portion 1c (tape 8) extending in the Z direction (axial direction). That is, the groove portion 2e extends in the Z-direction. The tape 8 has a length L1 in the Z-direction. The groove portion 2e has a length L2 in the Z-direction. The length L2 of the groove portion 2e is larger than the length L1 of the tape 8. Note that the groove portion 2e is an exemplary “recess” of the present disclosure.

FIG. 6 is a plan view showing the vicinity of the bulging portion 1c from Z1 side while the wound electrode body 1 is disposed in the case 2. As shown in FIG. 6, the tape 8 has a width W1 in the C direction (circumferential direction). The groove portion 2e has a width W2 in the C-direction. The width W1 of the tape 8 is smaller than the width W2 of the groove portion 2e. For example, the width W1 is not less than 0.5 times and not more than 0.9 times the width W2.

Specifically, the end 2f on C1 side of the groove portion 2e is disposed on C1 side than the end 8a on C1 side of the tape 8. The end portion 2g on C2 side of the groove portion 2e is disposed on C2 side than the end portion 8b on C2 side of the tape 8.

The tape 8 has a thickness t1 in the R-direction. The groove portion 2e has a depth d1 in the R-direction. The depth d1 of the groove portion 2e is larger than the thickness t1 of the tape 8. As a result, the entire tape 8 can be accommodated in the groove portion 2e.

The distance D1 between the outer peripheral surface 1a of the wound electrode body 1 and the inner peripheral surface 2c of the case 2 is smaller than the thickness t1 of the tape 8. Accordingly, at least a portion of the tape 8 (at least a portion of the case 2 side) is disposed so as to enter the inside of the groove portion 2e. The distance D1 is a distance corresponding to a circumferential position where the bulging portion 1c and the groove portion 2e are not provided.

As described above, in the first embodiment, the groove portion 2e is provided on the inner peripheral surface 2c of the case 2 at a position facing the bulging portion 1c (tape 8). As a result, the bulging portion 1c can be released to the groove portion 2e. As a consequence, it is possible to suppress a local load being applied from the case 2 to the wound electrode body 1 (bulging portion 1c).

### Second Embodiment

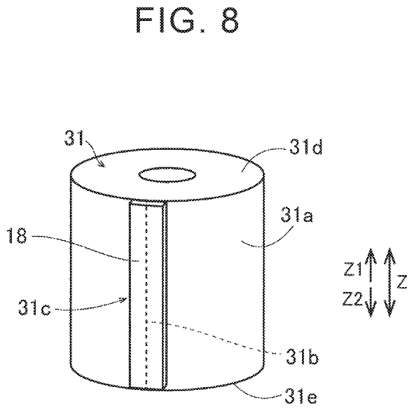

Next, a second embodiment of the present disclosure will be described with reference to FIGS. 7 and 8. In the second embodiment, an adhesive material 18 is used instead of the tape 8 of the first embodiment. The same components as those in the first embodiment are denoted by the same reference numerals as those in the first embodiment and will not be described repeatedly.

FIG. 7 is a partially enlarged plan view illustrating a configuration of the power storage cell 200. The power storage cell 200 includes a wound electrode body 31 and a case 2. The wound electrode body 31 includes an outer peripheral surface 31a, a terminal portion 31b, and a bulging portion 31c.

In the second embodiment, the bulging portion 31c is formed by the adhesive material 18 applied between the outer peripheral surface 31a and the groove portion 2e. The adhesive material 18 is disposed, for example, by filling the liquid adhesive material 18 into the gap S formed between the inner peripheral surface 2c and the outer peripheral surface 31a corresponding to the groove portion 2e with the wound electrode body 31 inserted (disposed) in the case 2. That is, the adhesive material 18 is disposed so as to fill the groove portion 2e and the space between the groove portion 2e and the outer peripheral surface 31a. The filled liquid adhesive material 18 is subsequently cured. Note that the wound electrode body 31 and the case may be combined with each other while the adhesive material 18 is applied to the groove portion 2e or the outer peripheral surface 31a in advance.

The wound electrode body 31 differs from the wound electrode body 1 of the first embodiment only in that an adhesive material 18 is provided instead of the tape 8.

The groove portion 2e is provided at a position facing the terminal portion 31b in the radial direction (R direction). The terminal portion 31b is covered from the radially outer side (R2 side) by an adhesive material 18 provided between the groove portion 2e and the outer peripheral surface 31a. As a result, the terminal portion 31b is fixed by the adhesive material 18.

The adhesive material 18 is provided so as to extend from C1 end portion 2f of the groove portion 2e to C2 end portion 2g in the circumferential direction (C direction).

FIG. 8 is a perspective view illustrating a configuration of the wound electrode body 31. As shown in FIG. 8, the adhesive material 18 is provided so as to extend from Z1 end 31d of the wound electrode body 31 to Z2 end 31e of the wound electrode body 31 on the outer peripheral surface 31a of the wound electrode body 31.

Other configurations are the same as those of the first embodiment, and therefore, repeated description will not be given.

### Third Embodiment

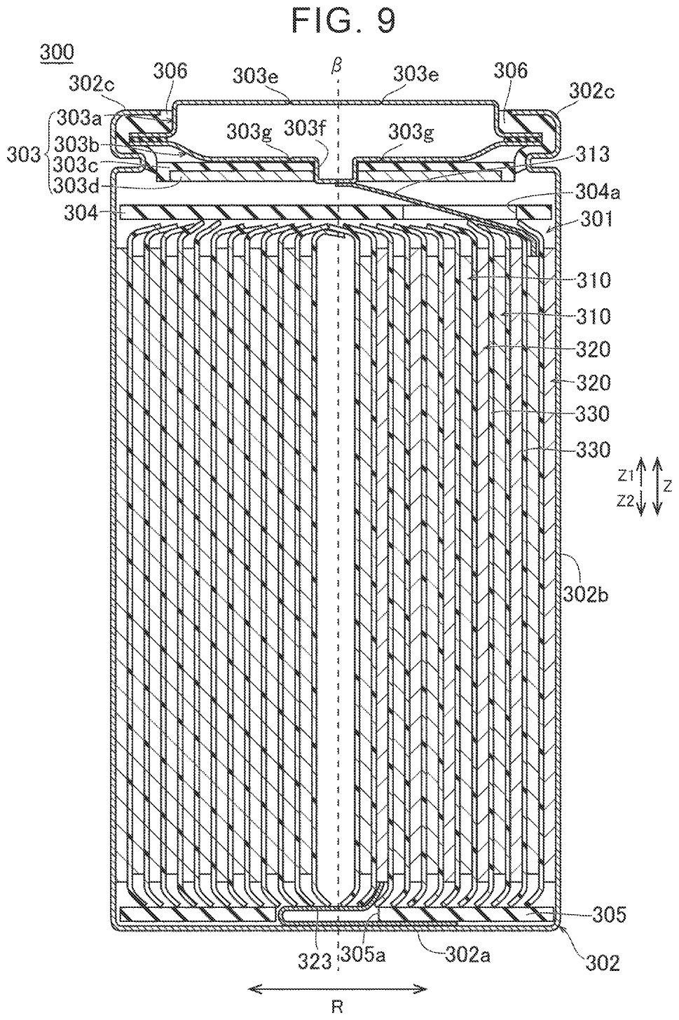

Referring FIGS. 9 to 16, a third embodiment of the present disclosure will be described. In the third embodiment, unlike the first and second embodiments, a bulging portion is formed by the tab lead.

FIG. 9 is a cross-sectional view showing an overall configuration of a power storage cell 300 according to a third embodiment of the present disclosure. The power storage cell 300 is, for example, a lithium-ion battery mounted on a vehicle. Note that the use and type of the power storage cell 300 are not limited to the above example.

The power storage cell 300 includes a wound electrode body 301, a case 302, a Current Interrupt Device (CID) 303, a positive-side insulating plate 304, a negative side insulating plate 305, and an insulating layer 306.

The wound electrode body 301 is accommodated in the case 302. The case 302 has a cylindrical shape. That is, the power storage cell 300 is a cylindrical battery. The case 302 is made of copper or aluminum, for example.

The wound electrode body 301 includes a positive electrode plate 310, a negative electrode plate 320, and a separator 330. The separator 330 is provided between the positive electrode plate 310 and the negative electrode plate 320. The separator 330 separates the positive electrode plate 310 and the negative electrode plate 320 while allowing ions (for example, lithium ions) to move back and forth between the positive electrode plate 310 (positive electrode active material) and the negative electrode plate 320 (negative electrode active material). The wound electrode body 301 is constituted by an electrode plate group in which a positive electrode plate 310 and a negative electrode plate 320 are wound with a separator 330 interposed therebetween. Each of the positive electrode plate 310 and the negative electrode plate 320 is an example of an “electrode sheet” of the present disclosure.

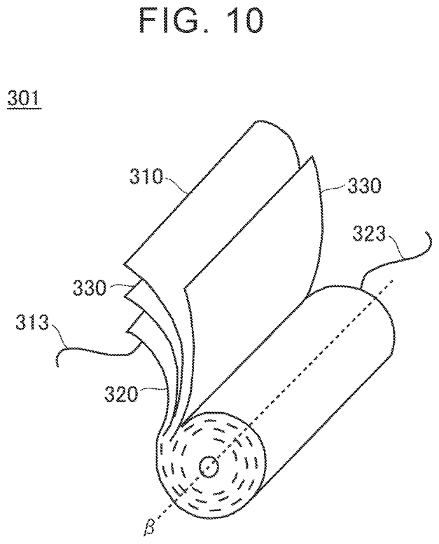

As shown in FIG. 10, the wound electrode body 301 is wound such that the positive electrode plate 310, the negative electrode plate 320, and the separator 330 surround the winding axis β. In FIG. 10, a state in which the winding of the wound electrode body 301 is slightly unwound is illustrated so that the winding state of the wound electrode body 301 can be easily understood.

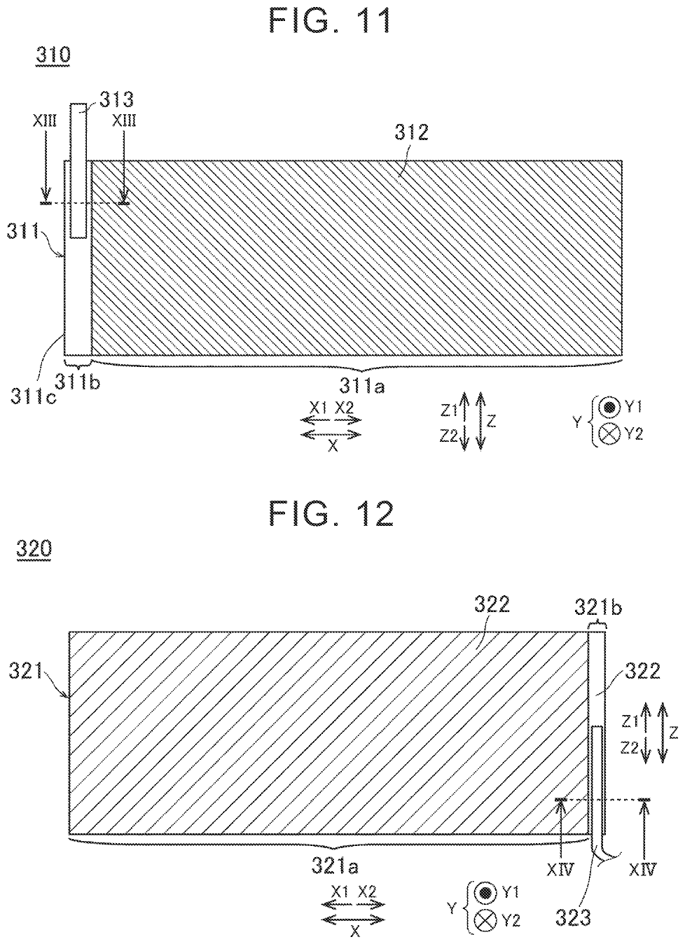

The positive electrode plate 310 includes a sheet-shaped positive electrode current collector 311 (see FIG. 11), a positive electrode mixture layer 312 (see FIG. 11), and a positive electrode tab lead 313. The negative electrode plate 320 includes a sheet-like negative electrode current collector 321 (see FIG. 12), a negative electrode mixture layer 322 (see FIG. 12), and a negative electrode tab lead 323. Note that each of the positive electrode current collector 311 and the negative electrode current collector 321 is an example of a “current collector” of the present disclosure. Each of the positive electrode tab lead 313 and the negative electrode tab lead 323 is an example of a “tab lead” of the present disclosure.

Referring again to FIG. 9, the positive-side insulating plate 304 is accommodated in the case 302. The positive-side insulating plate 304 is provided so as to insulate the wound electrode body 301 (the negative electrode plate 320 and the separator 330) from the case 302. The positive side insulating plate 304 is provided so as to cover the positive electrode current collector 311, the negative electrode plate 320, and the separator 330 from Z1 side.

The positive-side insulating plate 304 has a through-hole 304a. The positive electrode tab lead 313 penetrates through the through-hole 304a and contacts (is welded to) a conductive film 303b to be described later. Thus, the positive electrode tab lead 313 and the conductive film 303b are electrically connected to each other.

The negative side insulating plate 305 is accommodated in the case 302. The negative side insulating plate 305 is provided to insulate the wound electrode body 301 (the positive electrode plate 310 and the separator 330) from the case 302. The negative side insulating plate 305 is provided so as to cover the positive electrode plate 310, the negative electrode current collector 321, and the separator 330 from Z2 side.

The negative side insulating plate 305 has a through-hole 305a. The negative electrode tab lead 323 penetrates through the through-hole 305a and contacts the bottom 302a of the case 302. Accordingly, the negative electrode tab lead 323 and the bottom 302a of the case are electrically connected to each other. Consequently, the side surface portion 302b of the case 302 connected to the bottom 302a of the case 302 is negatively charged. The side surface portion 302b contacts the negative electrode current collector 321 of the negative electrode plate 320 provided on the outermost periphery of the wound electrode body 301.

CID 303 is a device that cuts off the current path by utilizing an increase in the internal pressure of the cell caused by the gases generated due to the overcharge of the power storage cell 300. CID 303 is provided to seal Z1 opening of the case 302. CID 303 includes an external cap 303a, a conductive film 303b, a gasket 303c, and a bottom disk 303d.

The external cap 303a functions as an external terminal by being electrically connected to an external busbar (not shown). The external cap 303a is provided with a fragile portion 303e (thin portion). When the internal pressure of the case 302 increases, the external cap 303a is easily broken starting from the fragile portion 303e. As a result, the gas is rapidly discharged to the outside of the case 302.

The conductive film 303b is provided to seal Z1 opening of the case 302. The conductive film 303b includes a protruding portion 303f protruding toward the wound electrode body 301 (Z2). The protruding portion 303f contacts the positive electrode tab lead 313. Accordingly, the conductive film 303b is positively charged. The conductive film 303b is electrically connected to the external cap 303a. As a result, the external cap 303a is also positively charged. Note that the protruding portion 303f is provided so as to penetrate through each of the gasket 303c and the bottom disk 303d.

Like the external cap 303a, the conductive film 303b is provided with a fragile portion 303g (thin portion). When the internal pressure of the case 302 increases, the conductive film 303b is easily broken starting from the fragile portion 303g. When the conductive film 303b is broken due to an increase in the internal pressure, the conductive film 303b and the positive electrode tab lead 313 are released from contacting each other. Consequently, the positive charge of the conductive film 303b is eliminated, and the positive charge of the external cap 303a is eliminated. As a result, charging and discharging of the power storage cell 300 are stopped.

The case 302 is provided with a caulking portion 302c that is caulked to the outer peripheral edge of the external cap 303a. The insulating layer 306 is provided so as to insulate the caulking portion 302c from the external cap 303a (and the conductive film 303b).

FIG. 11 is a Y1 view of the positive electrode plate 310 expanded in a sheet-like manner. The Y direction is a direction orthogonal to the positive electrode current collector 311 spread in a sheet shape. The positive electrode current collector 311 has a rectangular shape composed of a long side extending in the X direction and a short side extending in the Z direction. Note that the X direction is a direction corresponding to the winding direction of the wound electrode body 301. The Z direction is an example of the “axial direction” of the present disclosure. The Y direction is a direction corresponding to the R direction shown in FIG. 9. Further, the R direction is an example of the “radial direction” of the present disclosure.

As shown in FIG. 11, the positive electrode mixture layer 312 (hatched portion) is coated on a part of the positive electrode current collector 311. That is, the positive electrode current collector 311 includes a coated portion 311a on which the positive electrode mixture layer 312 is coated, and an uncoated portion 311b on which the positive electrode mixture layer is not coated.

In the embodiment illustrated in FIG. 11, the uncoated portion 311b is provided on X1 end 311c of the positive electrode current collector 311. The uncoated portion 311b is provided so as to extend along the Z-direction. In the third embodiment, X1 side and X2 side are the winding end side and the winding start side of the wound electrode body 301, respectively.

For example, aluminum or the like is used for the positive electrode current collector 311. The positive electrode mixture layer 312 is formed by coating a positive electrode slurry on the surface of the positive electrode current collector 311 and drying the slurry. The positive electrode slurry is a slurry prepared by kneading a material (a positive electrode active material, a binder, or the like) of the positive electrode mixture layer 312 and a solvent. The positive electrode mixture layer 312 is in close contact with the separator 330 (see FIG. 9). The thickness of the positive electrode mixture layer 312 is, for example, 0.1 μm or more and 1000 μm or less.

The positive electrode tab lead 313 is disposed on the uncoated portion 311b. The positive electrode tab lead 313 is provided so as to protrude axially (toward Z1) from the positive electrode current collector 311. The positive electrode tab lead 313 is provided at the center of the uncoated portion 311b in the X-direction.

FIG. 12 is a Y1 view of the negative electrode plate 320 expanded in a sheet-like manner. As shown in FIG. 12, like the positive electrode current collector 311, the negative electrode current collector 321 has a rectangular shape composed of a long side extending in the X direction and a short side extending in the Z direction.

For example, copper foil or the like is used for the negative electrode current collector 321. The negative electrode mixture layer 322 is formed by coating a negative electrode slurry on the surface of the negative electrode current collector 321 and drying the negative electrode slurry. The negative electrode slurry is a slurry prepared by kneading a material (a negative electrode active material, a binder, and the like) of the negative electrode mixture layer 322 and a solvent. The negative electrode mixture layer 322 is in close contact with the separator 330 (see FIG. 9). The thickness of the negative electrode mixture layer 322 is, for example, 0.1 μm or more and 1000 μm or less.

The negative electrode mixture layer 322 is coated on a part of the negative electrode current collector 321. That is, the negative electrode current collector 321 includes a coated portion 321a on which the negative electrode mixture layer 322 is coated, and an uncoated portion 321b on which the negative electrode mixture layer 322 is not coated. The uncoated portion 321b is provided so as to extend along the Z-direction.

The negative electrode tab lead 323 is disposed on the uncoated portion 321b. The negative electrode tab lead 323 is provided so as to protrude axially (Z2) from the negative electrode current collector 321. The negative electrode tab lead 323 is provided at the center of the uncoated portion 321b in the X-direction.

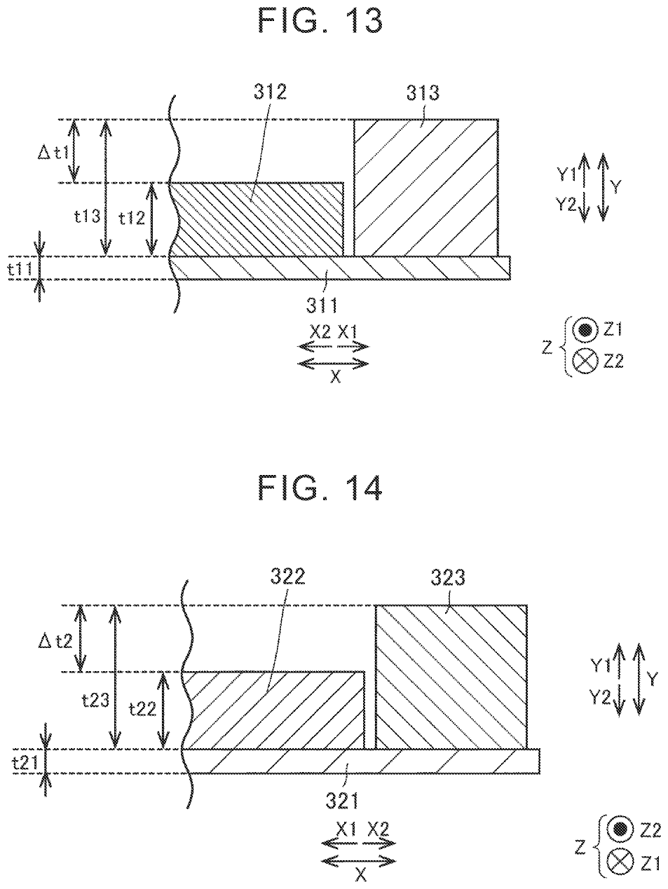

FIG. 13 is a cross-sectional view taken along XIII-XIII line of FIG. 11. As illustrated in FIG. 13, the positive electrode current collector 311 has a thickness t11 in the Y-direction. The positive electrode mixture layer 312 has a thickness t12 in the Y-direction. The positive electrode tab lead 313 has a thickness t13 in the Y-direction.

The thickness t13 of the positive electrode tab lead 313 is larger than the thickness t12 of the positive electrode mixture layer 312. The thickness t12 of the positive electrode mixture layers 12 and the thickness t13 of the positive electrode tab leads 13 are larger than the thickness t11 of the positive electrode current collector 311. The thickness difference Δt1 (t13−t12) between the thickness t13 of the positive electrode tab lead 313 and the thickness t12 of the positive electrode mixture layer 312 may be larger than the thickness t11 of the positive electrode current collector 311.

FIG. 14 is a cross-sectional view taken along XIV-XIV line of FIG. 12. As illustrated in FIG. 14, the negative electrode current collector 321 has a thickness t21 in the Y-direction. The negative electrode mixture layer 322 has a thickness t22 in the Y-direction. The negative electrode tab lead 323 has a thickness t23 in the Y-direction.

The thickness t23 of the negative electrode tab lead 323 is larger than the thickness t22 of the negative electrode mixture layer 322. Note that the thickness t22 of the negative electrode mixture layer 322 and the thickness t23 of the negative electrode tab lead 323 are larger than the thickness t21 of the negative electrode current collector 321. The thickness difference Δt2 (t23−t22) between the thickness t23 of the negative electrode tab lead 323 and the thickness t22 of the negative electrode mixture layer 322 may be larger than the thickness t21 of the negative electrode current collector 321.

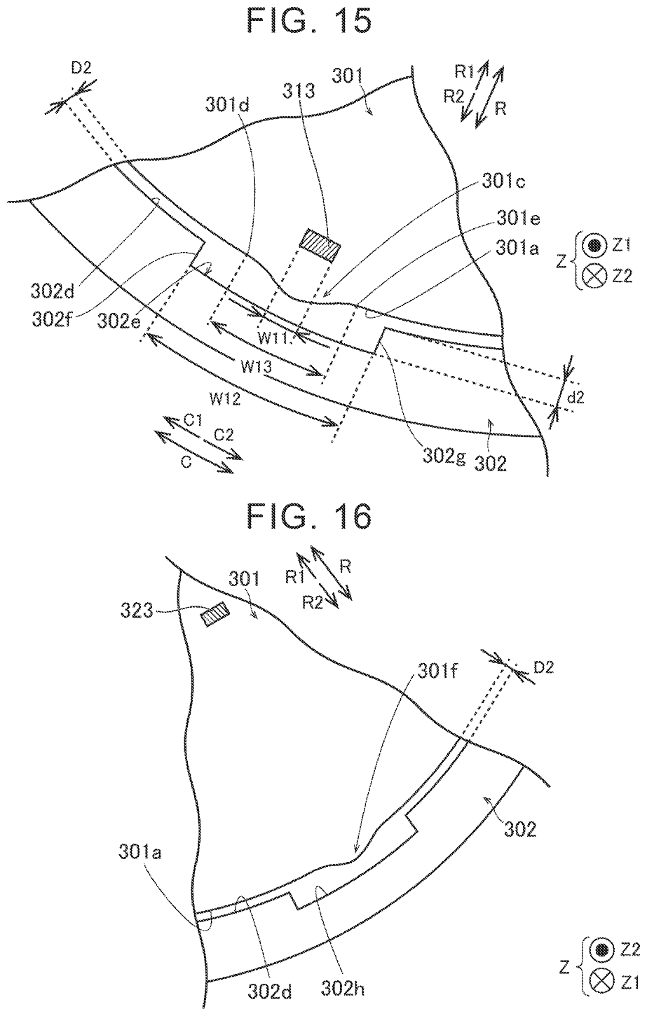

FIG. 15 is a partially enlarged plan view when the wound electrode body 301 is viewed from Z1. As shown in FIG. 15, in the third embodiment, the bulging portion 301c is formed on the outer peripheral surface 301a of the wound electrode body 301. The bulging portion 301c is formed by the positive electrode tab lead 313. Specifically, the bulging portion 301c is formed due to the thickness difference Δt1 (see FIG. 13) between the thickness t13 of the positive electrode tab lead 313 (see FIG. 13) and the thickness t12 of the positive electrode mixture layer 312. That is, the amount of bulging (the amount of protruding toward R2) of the bulging portion 301c is equal to the thickness difference Δt1.

The positive electrode tab lead 313 has a width W11 in the C-direction. The groove portion 302e has a width W12 in the C-direction. The bulging portion 301c has a width W13 in the C-direction. The width W13 of the bulging portion 301c is larger than the width W11 of the positive electrode tab lead 313. Note that the groove portion 302e is an exemplary “recess” of the present disclosure.

The groove portion 302e provided on the inner peripheral surface 302d of the case 302 is positioned R2 to the positive electrode tab lead 313. The positive electrode tab lead 313 is located at the center of the area in the C-direction where the groove portion 302e is provided. The shape of the groove portion 302e may be the same as the shape of the groove portion 2e of the first embodiment.

The width W12 of the groove portion 302e is larger than the width W13 of the bulging portion 301c. The end portion 302f on C1 side of the groove portion 302e is located on C1 side than the end portion 301d on C1 side of the bulging portion 301c. The end portion 302g on C2 side of the groove portion 302e is located on C2 side than the end portion 301e on C2 side of the bulging portion 301c. Note that the groove portion 302f is an exemplary “recess” of the present disclosure.

The groove portion 302e has a depth d2 in the R-direction. The depth d2 of the groove portion 302e is larger than the thickness difference Δt1 (see FIG. 13). As a result, the entire bulging portion 301c can be accommodated in the groove portion 302e.

The distance D2 between the outer peripheral surface 301a of the wound electrode body 301 and the inner peripheral surface 302d of the case 302 is smaller than the thickness difference Δt1. As a result, at least a portion of the bulging portion 301c (at least a portion of the case 302) is disposed so as to enter the inside of the groove portion 302e. The distance D2 is a distance corresponding to a circumferential position where the bulging portion 301c and the groove portion 302e are not provided.

In the third embodiment, only one positive electrode tab lead 313 is provided, but the present disclosure is not limited thereto. The plurality of positive electrode tab leads 313 may be arranged side by side in the R direction. In this case, the amount of bulge of the bulging portion 301c is equal to the value obtained by multiplying the number of positive electrode tab leads 313 aligned in the R direction by the thickness difference Δt1.

FIG. 16 is a partially enlarged plan view when the wound electrode body 301 is viewed from Z2. As shown in FIG. 16, a bulging portion 301f is formed on the outer peripheral surface 301a of the wound electrode body 301. The bulging portion 301f is formed by the negative electrode tab lead 323. Specifically, the bulging portion 301f is formed due to the thickness difference Δt2 (see FIG. 14) between the thickness t23 of the negative electrode tab lead 323 (see FIG. 14) and the thickness t22 of the negative electrode mixture layer 322. That is, the amount of bulging (the amount of protruding toward R2) of the bulging portion 301f is equal to the thickness difference Δt2.

The groove portion 302h provided on the inner peripheral surface 302d of the case 302 is positioned R2 to the negative electrode tab lead 323. The negative electrode tab lead 323 is located at the center of the area in the C-direction in which the groove portion 302h is provided.

Note that the relationship between the negative electrode tab lead 323, the bulging portion 301f, and the groove portion 302h (such as the relationship and the positional relationship) is the same as the relationship between the positive electrode tab lead 313, the bulging portion 301c, and the groove portion 302e described above. Therefore, repetitive description will not be given.

The distance D2 between the outer peripheral surface 301a of the wound electrode body 301 and the inner peripheral surface 302d of the case 302 is smaller than the thickness difference Δt2. As a result, at least a portion of the bulging portion 301f (at least a portion of the case 302) is disposed so as to enter the inside of the groove portion 302h.

In the third embodiment, an example in which only one negative electrode tab lead 323 is provided is shown, but the present disclosure is not limited to this. The plurality of negative electrode tab leads 323 may be arranged side by side in the R direction. In this case, the amount of bulge of the bulging portion 301f is equal to the amount obtained by multiplying the number of the negative electrode tab leads 323 aligned in the R direction by the thickness difference Δt2.

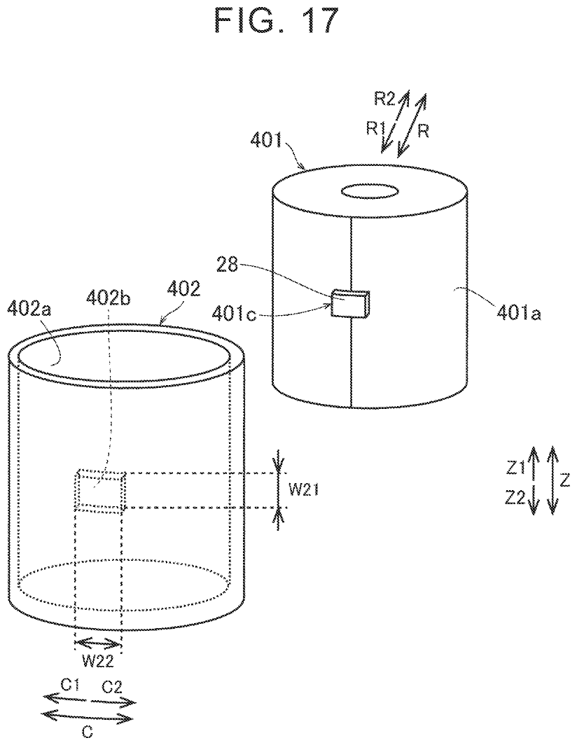

In I to of the third embodiments, the groove portion (2e, 302e, 302h) extending in the Z-direction is formed on the inner peripheral surface (2c, 302d) of the case (2, 302), but the present disclosure is not limited thereto. A recessed portion other than the groove portion may be formed. For example, in the embodiment illustrated in FIG. 17, the recessed portion 402b is formed on the inner peripheral surface 402a of the case 402 so as to correspond to the bulging portion 401c formed on the outer peripheral surface 401a of the wound electrode body 401. The recessed portion 402b is formed so that the width W21 in the Z direction is equal to or smaller than the width W22 in the C direction so as to correspond to the bulging portion 401c. In FIG. 17, the bulging portion 401c is formed by the tape 28, but the bulging portion may be formed by an adhesive material or a tab lead.

In the first embodiment, the tape 8 is provided on the terminal portion 1b of the winding of the wound electrode body 1, but the present disclosure is not limited thereto. The tape 8 may be provided at a position other than the terminal portion 1b. The same applies to the position of the adhesive material 18 of the second embodiment.

In the first and second embodiments described above, the wound electrode body of the tabless structure in which the tab lead is not provided is shown as an example, but the present disclosure is not limited thereto. In the first and second embodiments, a wound electrode body provided with a tab lead may be used as in the third embodiment.

In the third embodiment, an example in which the tab lead is provided in the uncoated portion has been described, but the present disclosure is not limited thereto. A tab lead may be provided on the coated portion. In this case, the thickness of the tab lead may not be larger than the thickness of the positive electrode (negative electrode) mixture layer. Further, in the third embodiment, the thickness difference Δt1 (Δt2) is smaller than the depth d2 of the groove portion and larger than the distance D2 of the gap between the case 302 and the wound electrode body 301, but the present disclosure is not limited to this when the tab lead is provided in the coated portion. The depth d2 and the distance D2 may be smaller than the depth d2 and larger than the distance D2 in the thickness t13 (t23) of the tab lead.

Note that the configurations of the above-described embodiment and the above-described modification examples may be combined with each other.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. A power storage cell comprising:
a wound electrode body that includes an electrode sheet and a separator; and
a case that accommodates the wound electrode body, wherein:
the wound electrode body is wound such that the electrode sheet and the separator surround a winding axis;
the wound electrode body includes an outer peripheral surface on which a bulging portion is formed;
the case includes an inner peripheral surface that faces the outer peripheral surface; and
a recessed portion is provided on the inner peripheral surface at a position facing the bulging portion.

2. The power storage cell according to claim 1, wherein:
the bulging portion is formed so as to extend in an axial direction of the wound electrode body; and
the recessed portion includes a groove portion provided so as to extend along the bulging portion.

3. The power storage cell according to claim 1, wherein:
the outer peripheral surface includes a terminal portion of winding of the wound electrode body;
the wound electrode body includes a tape attached to the terminal portion so as to maintain the wound electrode body in a wound state;
the bulging portion is formed by the tape; and
the recessed portion is provided at a position facing the tape.

4. The power storage cell according to claim 1, wherein the bulging portion is formed by an adhesive material applied between the outer peripheral surface and the recessed portion.

5. The power storage cell according to claim 4, wherein:
the outer peripheral surface includes a terminal portion of winding of the wound electrode body; and
the adhesive material is applied between the recessed portion provided at a position facing the terminal portion and the outer peripheral surface.

6. The power storage cell according to claim 1, wherein:
the electrode sheet includes
a sheet-like current collector, and
a tab lead that projects in an axial direction of the wound electrode body from the current collector;
the bulging portion is formed by the tab lead; and
the recessed portion is positioned radially outward of the wound electrode body with respect to the tab lead.
